(19) United States
(12) Patent Application Publication
(10) Pub. No.: US 2026/0278733 A1
(43) Pub. Date: Sep. 17, 2026

(54) SMART IMAGE SCALING

(71) Applicant: Fiery, LLC, Fremont, CA (US)

(72) Inventors: Patrick H. Wood, Lake Hopatcong, NJ (US); Sol Goldenberg, Rockaway, NJ (US); Holger Werner SCHUPPAN, Bottrop (DE)

(21) Appl. No.: 19/552,313

(22) Filed: Feb. 27, 2026

Related U.S. Application Data
(63) Continuation-in-part of application No. 19/055,980, filed on Feb. 18, 2025.
Application No. 19/055,980 is a continuation-in-part of application No. 18/629,759, filed on Apr. 8, 2024.

(51) Int. Cl. G06T 3/40; G06T 11/40; G06T 11/60; G06V 10/25

(52) U.S. Cl. CPC G06T 3/40; G06T 11/40; G06T 11/60; G06V 10/25

(57) ABSTRACT

Smart scaling of an image allows a single design to be scaled to accommodate multiple sizes and aspect ratios. Different graphic elements, e.g., bar codes, logos, objects, retain their size and position within the image even when the artwork must be stretched asymmetrically to fit a new size.

### CROSS-REFERENCE TO RELATED APPLICATIONS

This application is a continuation-in-part of U.S. patent application Ser. No. 19/055,980, filed Feb. 18, 2025, which is a continuation of U.S. patent application Ser. No. 18/629,759, filed Apr. 8, 2024, which are incorporated herein in their entirety by this reference thereto.

### TECHNICAL FIELD

Various of the disclosed embodiments concern smart image scaling.

### BACKGROUND

Over the last few years, retailers with large shipping operations have built warehouses capable of shipping thousands of boxes each day. Boxes come in many different shapes and sizes. Custom artwork for these boxes is designed for various marketing reasons, e.g., advertising, product tie-ins, and holiday promotions.

A box design can include many graphical elements, including photos, logos, coupons, seasonal graphics (e.g., snowflakes, pumpkins, turkeys), shipping labels, bar codes, and DOT labels (e.g., flammable, caustic, ground only).

The current art involves creating a 3D representation of the physical packaging and fitting text and images on the sides, either automatically or via a template, to prevent graphical elements from scaling unevenly. For any promotion, a designer must create a different layout for each supported box size. This is labor-intensive and often limits the number of sizes available, either requiring the shipper to use a specific size or forcing them to skip the promotion for certain size images.

For example, the artwork for a box measuring 8×8×8 inches on a side, if scaled to a box 16×8×8 inches, would have one side stretched larger while the other two remain the same size. Scaling the design along this one edge would distort some graphical elements unacceptably, e.g., a company's logo would become elongated, or a shipping label would be stretched beyond the dimensions required by the shipper.

### SUMMARY

In embodiments disclosed herein, smart image scaling enables a single design to be used across multiple image sizes. Different graphical elements, e.g., bar codes and logos, retain their aspect ratios even when the artwork must be stretched asymmetrically to fit a new size.

### BRIEF DESCRIPTION OF THE DRAWINGS

FIG. 1 is a plan view of an unfolded box;

FIG. 2 is a block diagram showing a smart box scaling system according to an embodiment of the present technology;

FIG. 3 shows a printer controller with an embedded scaling engine according to an embodiment of the present technology;

FIG. 4 is a flow chart diagram showing smart box scaling according to an embodiment of the present technology;

FIGS. 5A-5D show four images that demonstrate the steps of smart image scaling according to an embodiment of the present technology;

FIGS. 6A-6E show five images as they would appear on a box, demonstrating smart image scaling according to an embodiment of the present technology;

FIG. 7 shows the selection of a graphical element in the smart scaling app and different scaling attributes that can be assigned to it according to an embodiment of the present technology;

FIGS. 8 and 9 show previews of scaled boxes according to an embodiment of the present technology;

FIG. 10 shows two selected objects that overlap;

FIG. 11 is a block diagram of a computer system as may be used to implement certain features of some of the embodiments.

### DETAILED DESCRIPTION

Images are often used in marketing and shipping to provide consumers with information about the retailer's product or the goods within a container. A common way that retailers ship goods is via boxes. Boxes, like images, come in a variety of sizes. Some are cubic while others are rectangular. Some are short and others tall. Consequently, the proportions of the box panels and flaps vary independently. Designers must be aware that when the box shape changes, the graphical elements on it may scale, either larger or smaller, in unexpected ways, creating problems for the customer. For instance, if a box contains a square logo and is designed for a rectangular surface measuring 16″×8″, the logo is distorted when scaled to fit a square 8″×8″ surface.

The disclosed solution to these design problems allows the designer to specify the graphical elements that require special consideration when the design is scaled to different sizes.

Another design goal is to minimize changes to the designer's current processes and workflows. The input and output are typically a page description language file, e.g., PDF or PostScript.

Embodiments disclosed herein allow a graphic designer to create a single image design that can be appropriately scaled for a variety of sizes and shapes.

### Glossary

Design template/file: Outlines drawn in custom colors that describe the layout of the box panels, flaps, and optionally graphic elements that require special handling, and the file it is saved to.
Scaling attributes: Scaling and placement constraints are placed on one or more graphical elements so they can scale independently of the panel they are on.
Aspect ratio: The relationship between the length and width of an image. Ex. If an image is 8″×8″, its aspect ratio is 1:1 because the length and width are equal. However, if the image is 8″×12″, its aspect ratio is 2:3, since one side is ⅔ the size of the other.
Rule: Combination of graphical element(s) and scaling attributes.
Control information: Rules, VDP information, and panel boundaries.
Smart scaling file: File combining the master design file, rules, and (optionally)
Panel: One face of a box.
Background image or Perl Data Language (PDL) file: Box design background that is either not scaled at all or is only scaled to fit the entire sheet the box is printed on, and not differently based on the width, height, or depth scaling of the box.
Variable data printing (VDP): Placing a different graphic element, e.g., shipping label, bar code, on every box without creating a new box design for each instance. Typically performed by replacing proxy or placeholder elements with an image or small PDL files.
Inpainting: Inpainting replaces or edits specific areas of an image. This makes it a useful tool for image restoration, like removing defects and artifacts, or even replacing an image area with something entirely new. Inpainting relies on a mask to determine which regions of an image to fill in; the area to inpaint is represented by white pixels, and the area to keep is represented by black pixels. The prompt fills in the white pixels. (see https://huggingface.co/docs/diffusers/using-diffusers/inpaint).
Outpainting: Outpainting continues an image beyond its original borders, for example, adding or expanding visual elements in the same style. (see https://openai.com/blog/dall-e-introducing-outpainting).

### Discussion

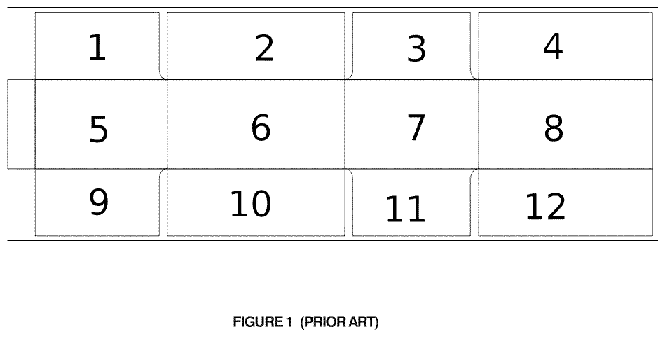

FIG. 1 is a plan view of an unfolded box. A typical box has six faces: front, back, left side, right side, top, and bottom. The front, back, and sides are called “panels” (5, 6, 7, and 8 in FIG. 1). The top and bottom of a box are split in half and folded over; these halves are called “flaps.” The wider flaps (2, 4, 10, and 12 in FIG. 1) are on the outside of the box, and anything printed on them is visible. The narrower flaps (1, 3, 9, and 11 in FIG. 1) are folded under the wider flaps and are typically not printed on.

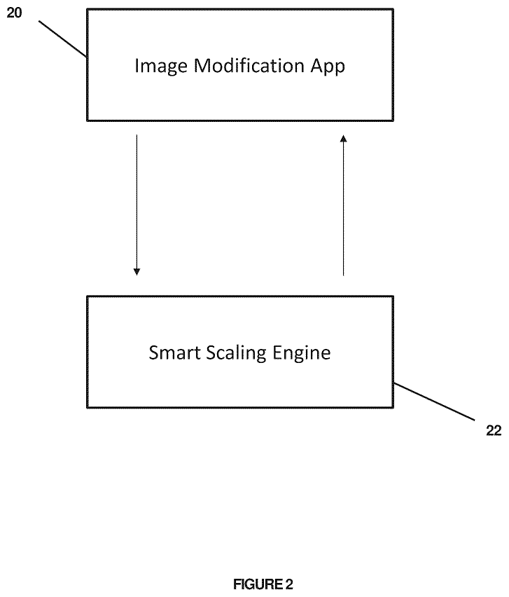

FIG. 2 is a block diagram showing a smart image scaling system. Some embodiments disclosed herein comprise the following elements. Those skilled in the art will appreciate that these elements may comprise separate components, each associated with a different portion of the image design and print workflow, or they may be combined in any combination as appropriate for the application in which they are deployed.

Smart Image Scaling App. The image modification app 20 includes the user interface (UI) and overall prepress control code. When the user selects a master image design file, the app prompts them to select the object, or objects, within the image they want to scale separately. After the object is selected, the app determines information about the location of some or all the graphical elements in the file. After the location information is collected and stored, the image modification app 20 removes an object, or multiple objects, from the image. In some embodiments, the image modification app has a built-in inpainting feature. In these embodiments, the image modification app then proceeds to inpaint the image to fill in the area that was covered by the removed object(s). After the object has been removed and the inpainting has occurred, the image modification app 20 sends the image to the smart scaling engine 22, which produces the final box PDL file(s) or saves the information in the smart scaling file. In other embodiments, there is a separate inpainting app that is used after the image modification app 20 has removed the necessary objects from the initial image.

Smart Scaling Engine. The smart scaling engine 22 inputs the master box design file and control information, either from a single smart scaling file, from separate files, or from memory, along with the dimensions of the image or images. In some embodiments, the smart scaling engine measures the dimensions of the image; in other embodiments, this information is sent to the smart scaling engine 22 from a separate file or application. In both embodiments, the smart scaling engine 22 then scales the image using a process (discussed in detail below) that prevents unwanted smearing or blurring, ensuring the image does not appear stretched but is correctly scaled.

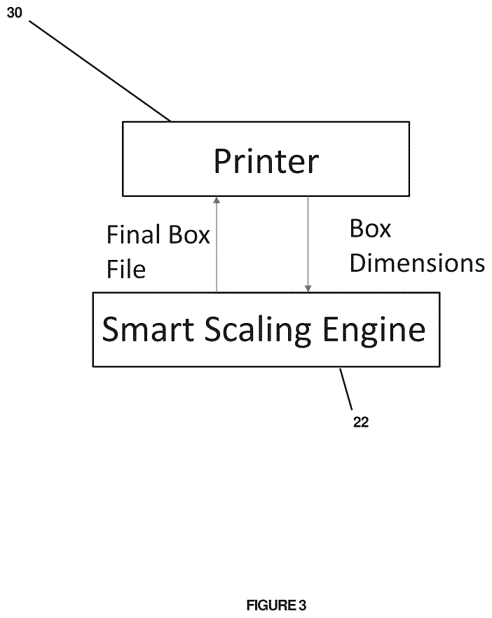

FIG. 3 shows a printer controller with an embedded scaling engine according to an embodiment disclosed herein. The scaling engine reads the smart scaling file, control information (which may be embedded in the smart scaling file), and box dimensions+VDP replacement files to print one or more boxes of different scales and/or with different VDP elements. The smart scaling file can be sent to a printer 30 for production-time scaling by a separate smart scaling engine 22, allowing printing of arbitrarily scaled images at facilities physically separate from where design occurs, e.g., a warehouse or third-party fulfillment facility.

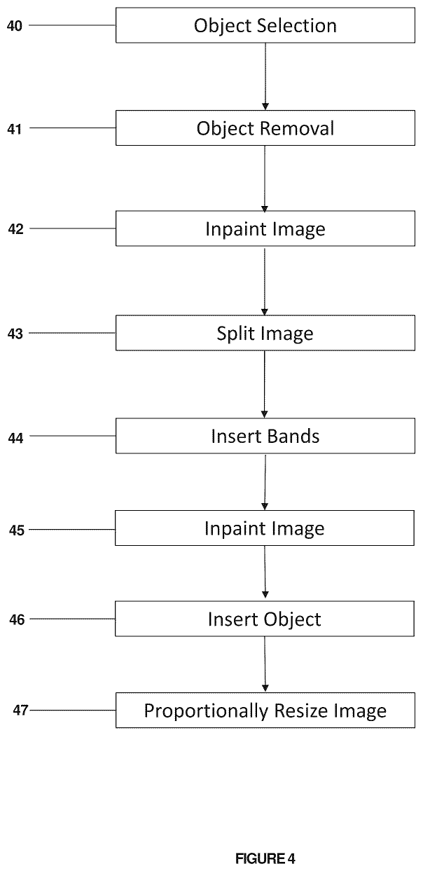

FIG. 4 shows a design system or method according to an embodiment disclosed herein. Other embodiments may perform only a portion of the steps therein. Still, this embodiment demonstrates a process that starts with an unaltered initial image and produces a ready-for-use image. The process begins with an initial image. The system then selects an object 40 within the initial image. Next, the system removes object 41 from the image, leaving an empty space. In some embodiments, the empty space may take on some color or be represented by pixels that no longer store any information. The resulting image is object-free and contains an area that is no longer part of the initial image.

The process in FIG. 4 then uses an inpainting program 42 to fill in the missing portion of the image. At this point, the image looks like the initial image if it were taken or created without the object. Inpainting 42 can occur in several ways. Some programs may call an external inpainting program, while others may use a built-in one that is called after the object is removed from the initial image. After the image is inpainted, the image can be sent to a new program that performs the following steps. In other embodiments, the system performing this process may be cohesive, so that a single system can perform all steps; in this case, the next step would begin immediately. In other embodiments, the user may need to take the image from a separate inpainting program and copy or drag it into a separate program that performs the next step or steps.

The process in FIG. 4 proceeds by splitting image 43 into bands of some width. The bands may be the same width, or multiple widths, depending on the desired aspect ratio of the final image. Once the image has been split 43, empty bands are inserted 44 into the image. In this embodiment, the user may use a variety of methods to determine how to insert the bands, but in other embodiments disclosed herein, specific methods of determining the proper band widths will be discussed. Once the alternating bands are inserted into the image, the system is left with a partial image. At this stage, the partial image has the same aspect ratio as the desired final image; however, some, or perhaps even most, of the image is empty.

At this point, we have a scaled partial image with the same aspect ratio as the desired final image. However, the scaled partial image contains empty regions, resulting from inserting bands 44. Next, we will inpaint image 45 a second time to fill the gaps left by the band insertion 44. In some embodiments, the system may use the same inpainting program used in step 42, and in other embodiments, it may use a different program. However, the image is still missing the object it started with. The next step of this program is to insert the object 46 back into the newly scaled image. After the object has been inserted back into the image, we are left with a smart scaled image with the same aspect ratio as the desired final image. However, in some implementations, the desired final image may be proportionally larger or smaller than the current image. Therefore, in some examples, we will need to proportionally resize the image 47 so that the smart scaled image is the same size as the desired final image.

In some embodiments of the technology, the image modification app 20 performs steps 40-42 of the above process. In these embodiments, the smart scaling engine 22 performs steps 43-44, and then the image modification app 20 performs steps 45-47. In other embodiments, additional applications may perform steps in the process. In one example of an alternative embodiment, there may be a separate inpainting program that is called by the image modification app after step 41, and the inpainting program performs steps 42 and 45 of the described process. In other example embodiments, the smart scaling engine 22 may perform all of the steps of the method in FIG. 4.

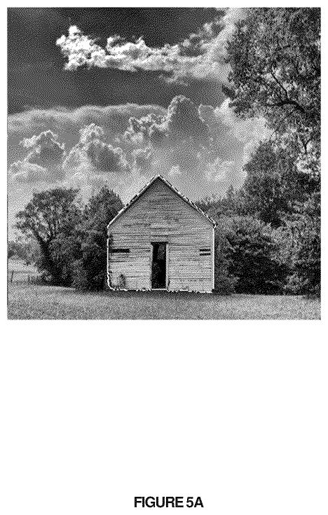

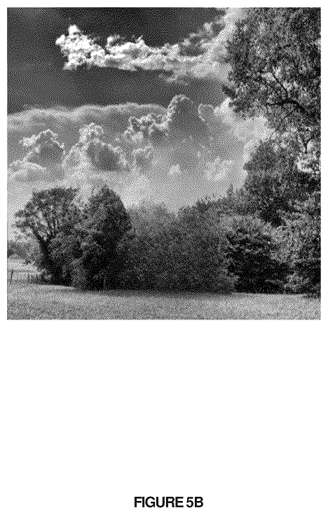

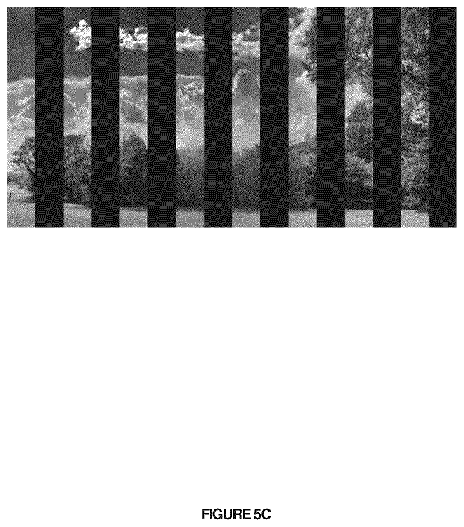

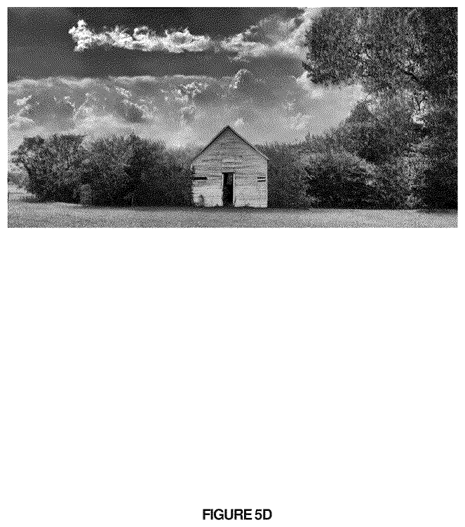

FIGS. 5A-5D demonstrate an embodiment using an image of a farmhouse in a rural setting.

The embodiment begins with FIG. 5A, which shows an initial image. The initial image has a background of trees and a sky with clouds. The image also has a house. This image provides a beneficial example of the smart scaling process disclosed herein, because the initial image in FIG. 5A has a house that is proportional to the trees around it. Additionally, the house has a standard A-frame and a doorway in the center. If this image were scaled to twice its original height via conventional stretching, the house would appear very long and skinny. If the image were expanded horizontally via conventional stretching, then the house would appear unnaturally wide. The systems and methods disclosed herein provide embodiments that allow a user to scale this image without distorting the house or the surrounding background.

The embodiment proceeds with FIG. 5B. FIG. 5B provides an image of the background setting of the previous image, wherein the house has been removed, and the image has been filled in. To get from FIG. 5A to FIG. 5B, three steps were performed. The house from FIG. 5A was selected 40, the house was removed 41, and the image was inpainted 42. Thus, creating FIG. 5B. In some embodiments, the object modification app 20 may be used to turn FIG. 5A into FIG. 5B.

The embodiment then proceeds to FIG. 5C. FIG. 5C shows the background setting of the previous image, with the background split and expanded to achieve a desired aspect ratio. To get from FIG. 5B to FIG. 5C, two steps were performed. First, FIG. 5B was split 43 into segments. Second, alternating empty bands were inserted 44 into the image, leaving black spaces between the remaining bands and creating a wider image with a new aspect ratio.

The embodiment then proceeds to FIG. 5D. FIG. 5D provides a new version of the initial image that has been smart scaled so that the house within the object remains proportionate to its surroundings, but with a wider aspect ratio than the initial image. To get from FIG. 5C to FIG. 5D, two steps were performed. First, the scaled partial image 5C was inpainted 45 to form a completed scaled image. Second, the object from the initial image was inserted 46 into the completed scaled image to form a final image. We see that this embodiment demonstrates the process described in FIG. 4 applied to an image. However, since altering the aspect ratio of the initial figure resulted in a final image with both the desired final aspect ratio and size, step 47 was not needed. In some embodiments, the object modification app 20 may be used to turn the image in FIG. 5C into the image in FIG. 5D.

For these embodiments, it does not matter whether the initial image needs to be scaled horizontally or vertically. The process used to scale FIG. 5A to create FIG. 5D also works for images that need to be scaled vertically. However, the process changes slightly. Specifically, in these embodiments, once the image has been inpainted 42, it will be split 43 along the vertical axis, rather than the horizontal axis, as shown in FIG. 5C. While the splitting 43 and band insertion 44 will occur along a different axis, the precise number of bands created and the relative scale of the band widths remain unchanged, although the band width will now be measured from top to bottom rather than from left to right.

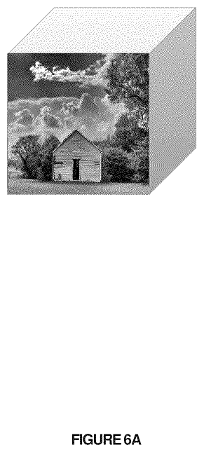

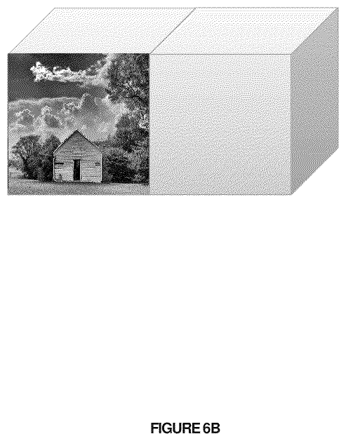

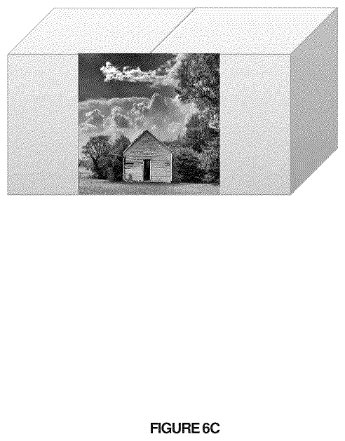

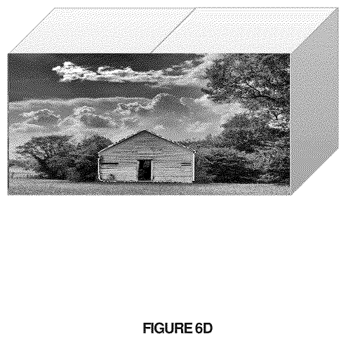

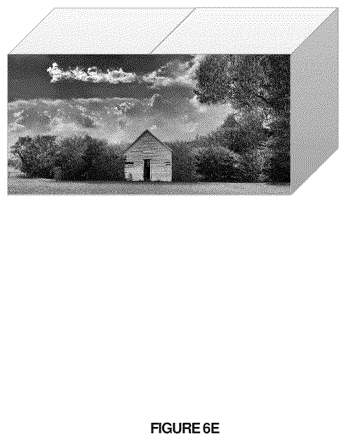

FIG. 6A shows the original image from FIG. 5A on a box whose dimensions fit it perfectly. If we want to scale the box horizontally by a factor of two, the image from FIG. 6A could either be placed in the leftmost portion of the larger box, as shown in FIG. 6B, or moved to the center of the larger box, as shown in FIG. 6C. With conventional scaling, the image would be stretched disproportionately, resulting in FIG. 6D, where the farmhouse, trees, and clouds appear unnatural. However, if the smart image scaling process described in FIG. 4 is applied to the initial image in FIG. 5A to produce the smart-scaled image shown in FIG. 5D, it results in the larger box in FIG. 6E, which looks natural because it keeps the proportions of the objects in the image.

### Size and Aspect Ratio

The previous embodiments provide examples of situations in which the initial image is scaled up from a small image to a larger one. However, the disclosed process can be used to enlarge or reduce an image's size. The smart scaling process works independently of the overall sizes of the initial and desired images. The previous embodiments instead focus on the change in aspect ratio from one image to the next. The aspect ratio, rather than the relative size, is critical to the scaling mechanism.

Regardless of the image's initial and final sizes, we first determine the aspect ratios of the initial and final images. Resizing the aspect ratios can occur in various ways, but the following process will provide an example embodiment.

Returning to our example in FIG. 6B, we see that the initial image with the house has an aspect ratio of 1:1, and the desired final image size (that of the box) has an aspect ratio of 1:2. Since in this example our vertical dimension is already aligned with the final image and the horizontal image needs to be expanded to attain the aspect ratio of the desired final image, this example is ready to be smart scaled as described above.

Suppose instead that the box is twice as long as it is tall. Then our initial image would still have an aspect ratio of 1:1, while our final image would have an aspect ratio of 2:1. In this example, our horizontal dimension would align with the final image, and our vertical dimension would need to be expanded. We would need to perform the same process as described in FIG. 4, but instead split the image 43 and insert the bands 44 along the vertical axis.

Now, suppose that the initial image was larger than the desired final image, such that the image ultimately needs to shrink to attain the proper size. In this example, the steps 40-46 remain unchanged because the aspect ratios are unitless and can always be defined so that one side of the initial image aligns with the corresponding dimension of the final aspect ratio, and the other side of the initial image is smaller than the corresponding dimension of the desired aspect ratio. Once the system has determined which side to expand and by how much, smart scaling proceeds with steps 40-46, which follow the same process as before, scaling either vertically or horizontally as needed. However, in this example, the final step of proportionally resizing the image 47 is required to proportionally shrink the image to the desired final size. In other embodiments of the technology, the initial image may be proportionally shrunk or enlarged before the start of the process in FIG. 4, rendering step 47 unnecessary. In other embodiments, the image may enter the system pre-sized, such that the output after step 46 always produces a correctly sized final image.

In some embodiments, the system may include a scanner or other measuring tool that receives an initial image and a final template, and measures these to determine their sizes. In one embodiment, the measuring tool provides this information to the smart scaling engine. This information can then be used to determine the aspect ratios of the initial and desired images, and to derive scaling parameters for slicing the image and the appropriate number of bands to include. These measurements can also be used to determine the dimensions of the initial and final image so that the image can be pre-scaled, as described above, so that one dimension of the initial image is the same as the corresponding dimension of the template, and the other corresponding dimension is smaller than the corresponding dimension of the final template.

In some implementations of this embodiment, the scaling engine may have prestored aspect ratio comparisons for common-sized templates and initial images. These prestored settings may be used to automate the process or improve its computational efficiency, particularly when standard sizes for initial and final images are used, as in box-making.

While some embodiments of the disclosed system and process may be used to scale images for boxes, other embodiments may be used to scale images for other purposes, such as making T-shirts or other merchandise, or for marketing uses, such as scaling for billboards and fliers. Embodiments of the disclosed process can be applied to any situation in which an image needs to be scaled, or its aspect ratio changed to prevent distortion.

### Object Removal

In some embodiments of the disclosed process and system, one or multiple objects can be removed from the initial image, as shown in FIGS. 5A to 5B. Some embodiments may allow a user to select multiple objects in the same image and remove all of them from the image. In these embodiments, the system may remove the objects 41 one at a time and then proceed to inpaint the object 42 after each removal. Alternatively, the system may allow the user to select multiple objects at once and remove all the objects 41 before proceeding to the inpainting step 42. In both cases, it is necessary to remove all objects before the image is split 43, so that portions of the object(s) are not removed from the image during band insertion 44 and image scaling 45.

For object removal 41, there are multiple ways to successfully remove an object. Some embodiments may use artificial intelligence (AI) systems to allow a user to circle or tap the desired image. In both cases, the AI system will determine the object's boundaries and use them to decide which portions of the initial image must be removed to ensure that the object and the remainder of the image are preserved. In some examples, the user may work with the AI system to improve its object detection. In other examples, the user may draw a boundary in the initial image that encases the object, and their preference will be used to determine what portions of the image must be removed. In some embodiments, the system may use an AI tool to automatically identify common image attributes whose aspect ratios should be preserved and remove them without any user interference. Examples of common objects include trademarks of well-known companies, bar codes for scanning packaged goods, or faces of people or characters that commonly appear on goods in a particular industry.

For embodiments that are removing an object or objects, the system determines the object's location within the original image and stores this information, as well as the object itself, so that the object can be put back into the image in the same relative position that it was removed from. There are several ways that the system can acquire this position data. Still, in embodiments where the image needs to be placed back in its original position, the relative position(s) of the object(s) must be determined so that, when the object(s) are returned to the scaled image, they are in the same position(s) they were in before they were removed.

In some embodiments, the user may want the object placed somewhere other than where it was initially. In these embodiments, data relating to the object's original relative position in the initial image is not used, and the user provides a new location for the object in the final scaled image. Alternatively, in other embodiments, the system may automatically return the object(s) to their original position. Still, the software may allow the user to select and drag the object(s) elsewhere on the image or even scale the image up or down. This may be particularly useful when there is a significant difference in the aspect ratios of the initial and final images, where inpaintings 42 and 45 will fill in a relatively large portion of the image. In these instances, a portion of the image may appear less clear than the rest, so expanding the object may allow the user to cover this area.

### Scaling

Embodiments of the disclosed system and method provide a way to scale images using a smart scaling engine 22. The smart scaling engine 22 may encapsulate a single system that performs all steps from receiving an initial image to providing a new scaled image, or it may only perform splitting 43, band insertion 44, and inpainting 45. Starting with splitting the image 43 and proceeding to band insertion 44, some embodiments of the process involve slicing the initial image and inserting bands 44. These bands may have alternating widths, resulting in two sets of bands. In this example, the first set of bands has width A, and the second set has width B. Looking at the example in FIG. 5C, we see that when the image is smart scaled to an aspect ratio with a width twice that of the initial image, the scaled partial image will have bands of widths A and B that are similar in size.

In most embodiments disclosed herein, the size of the inserted bands will grow as the relative scale of the image grows in a given direction. Hence, if the image is scaled from an initial aspect ratio of 1:1 to a size of 1:2, the inserted bands will be smaller than if the initial image size were 1:1 and the desired size were 1:3.

In some embodiments, the number of bands needed to perform this process will vary depending on the relative scaling of the aspect ratio of the initial image. In some embodiments, the number of bands used will increase as the amount of scaling increases. Therefore, if the image is scaled from an initial aspect ratio of 1:1 to a size of 1:2, there will be fewer total bands than if the initial image size were 1:1 and the desired size were 1:3. If the number of bands becomes too large, the inpainting model 45 will lack sufficient material to work with, resulting in a less clear image. In other embodiments, splitting 43 may use a fixed number of bands regardless of the change in aspect ratio.

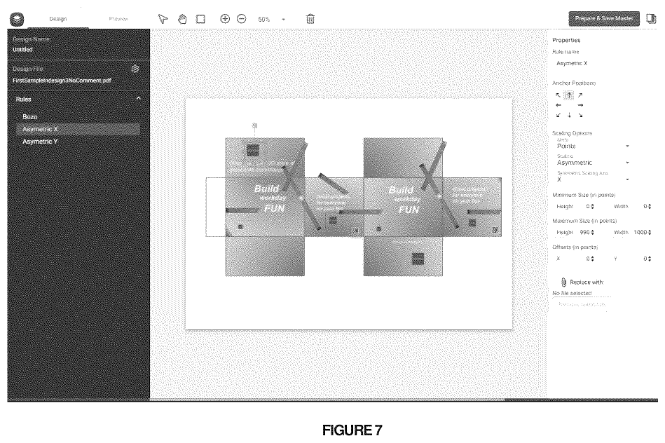

FIG. 7 shows a design template according to an embodiment of the present technology. Embodiments disclosed herein supply an Adobe InDesign template, but those skilled in the art will appreciate that embodiments could be applied to other graphics design packages, such as Adobe Illustrator, QuarkXPress, etc. These embodiments find the rectangles drawn in the special spot colors and use them to determine the initial dimensions of the box and panels/flaps and to determine which panel(s)/flap(s) an annotated graphical element may reside on. Any colors can be used as spot colors except those colors that could be a pigment, e.g., Cyan, Magenta, Yellow, Black, Gray, Blue, Green, Orange, Pantone colors, metallic inks, and so on. While the spot colors are removed from the final box file for printing, they may be retained when previewing a scaled box with the scaled images on screen or when printing proof copies to allow designers to verify proper placement and scaling of graphical elements and panels. Those skilled in the art will appreciate that other methods could be used to mark the panel boundaries, e.g., the designer could start from a fixed layout, or the designer could draw the box panels directly into the design using unique colors or some other unique design feature that the system could detect automatically.

FIG. 7 shows the selection of a graphical element in the smart image scaling app and different scaling attributes that can be assigned to it according to an embodiment disclosed herein. The smart image scaling app allows the designer to create a rule by selecting different graphical elements on the box and annotating them with advanced scaling attributes. For example, logos and QR codes should maintain their aspect ratio even if the panel or flap they are on is not scaled symmetrically. Other graphical elements, such as shipping labels, may need to remain the same size and shape regardless of box size and may require minimum offsets from a panel's side or corner to conform to marking requirements such as shipper or DOT requirements. QR codes, barcodes, and text may require a minimum size.

Scaling attributes applied to a graphical element may include, for example, any of the following:
Symmetric (equal horizontal and vertical), asymmetric, or no scaling;
For symmetric scaling, the side that the scaling is relative to;
Minimum and/or maximum width and/or height;
Fixed offset from a center, corner, or side;
Relative offset from the center, a corner, or side; and/or
Minimum offset from a corner or side.

Embodiments disclosed herein provide variable data printing (VDP) which places a different graphic element, e.g. shipping label, bar code, on every box without creating a new box design for each instance. VDP is typically performed by replacing proxy or placeholder elements with images or small PDL files. Returning to FIG. 4, the designer may specify graphical elements that are replaced at print time with something specific to that shipment 40, e.g. shipping address, tracking barcode, DOT labels, or a customer-targeted web site URL encoded in a QR code. These can be drawn, for example, with a custom spot color or other color in the master box design and flagged for replacement in the app for later substitution. They may also be drawn in the design template and locked in place with default scaling attributes so they are always in the same place, scale properly across multiple promotions, and cannot be repositioned or redrawn later by a designer.

In a different embodiment, these graphical elements could be added directly via annotations in the smart image scaling app. Any graphical elements that are not annotated with special scaling attributes are scaled with the same ratios as the rest of the image they are on.

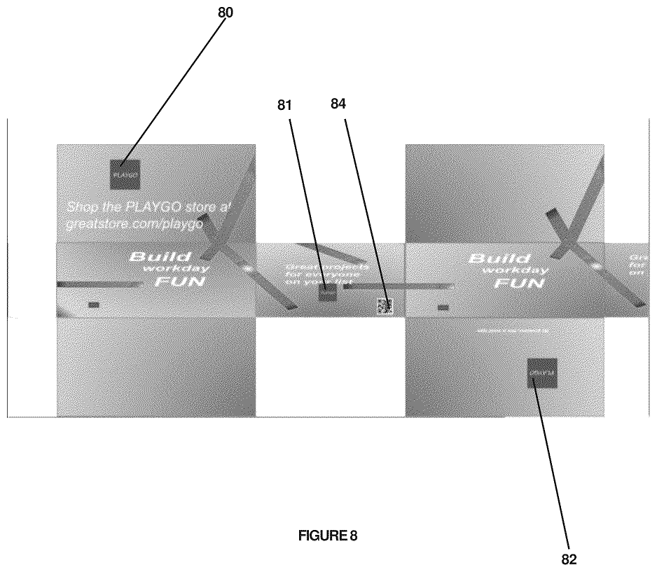

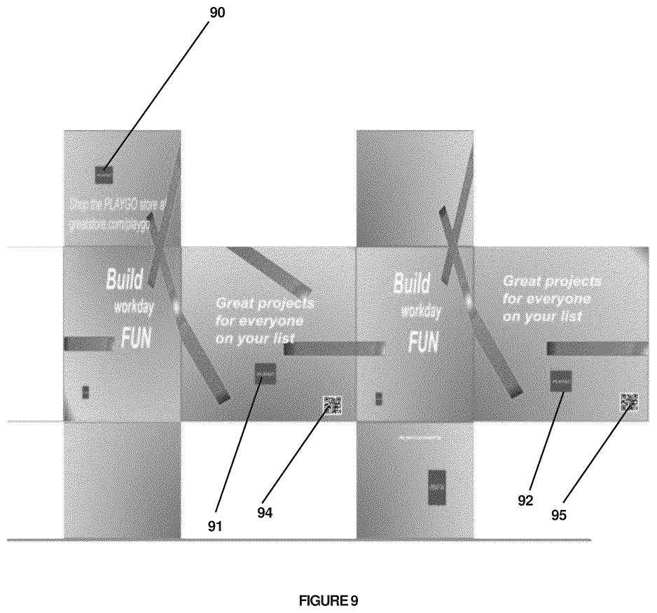

Once the designer has marked all graphical elements that require special scaling, he can preview boxes scaled to different sizes from a user interface. See FIGS. 8 and 9 which show previews of scaled boxes according to an embodiment in which a box design is stretched horizontally (FIG. 7) and stretched vertically (FIG. 8). Notice how the logos 80-82 (FIG. 8), 90-92 (FIG. 9) and QR codes 84 (FIGS. 8), 94, 95 (FIG. 9) in panels 1, 7, and 8 remain square regardless of the relative width and height of the panels, while the logos on the other panels scale differently in the vertical and horizontal directions. Also note how the text and graphics scale relative to the panels' sides on all panels, independent of the logo and QR code scaling, and the graphics that cross panel boundaries meet up at the edges.

Other embodiments disclosed herein may apply selection and scaling to boxes of varying shapes and layouts, e.g. with top and/or bottom faces that are not split in half-sized flaps but are full sized with a small tab that folds into the box, removable tops, more than six faces, cylindrical, hexagonal, etc., different materials, such as non-corrugated cardboard, plastic, fiberboard, cloth, tile, or any material with a printable surface, or even non-box/non-shipping products such as building wraps or 3D printed objects. Embodiments can also be applied to printing both the inside and outside surfaces of a box or other construct.

Another embodiment disclosed herein applies the different scaling attributes to one or more whole images, for example one per panel or one per box, using AI techniques based on “inpainting” and “outpainting” to add and remove parts of an image as needed to allow combining the different annotated areas into a single, visually pleasing image scaled to the proper box dimensions.

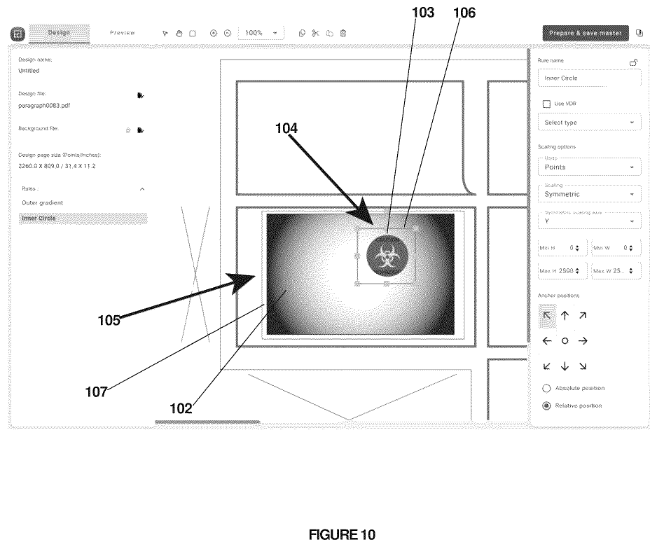

FIG. 10 shows two selected objects, 102 and 103, that overlap. Embodiments disclosed herein provide disambiguation of rules with custom spot colors. In this embodiment, the designer draws enclosing rectangles 106, 107 in different custom spot colors around each object when creating the master box design. Each rectangle completely encloses only one object. The analysis engine separates the objects into different pages in the master file, and the smart scaling app automatically applies different rules, e.g., an inner circle rule 104 and an outer gradient rule 105 to the entire background composed of the tile.

### Additional Use of AI

AI techniques such as detection (https://www.ibm.com/think/topics/object-detection) and segmentation (https://www.ibm.com/think/topics/image-segmentation) can be used to identify different design elements that may require certain rules, e.g., natural images, logos, bar codes, and shipping labels. Based on such identification an embodiment disclosed herein automatically apply preset rules to these elements.

### Computer Implementation

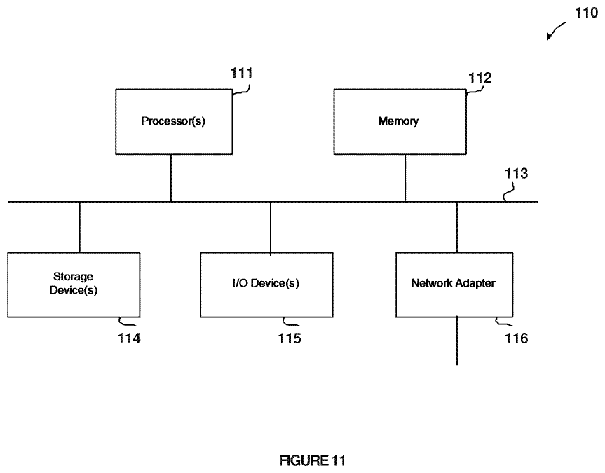

FIG. 11 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 110 may include one or more central processing units (“processors”) 111, memory 112, input/output devices 115, e.g., keyboard and pointing devices, touch devices, display devices, storage devices 114, e.g., disk drives, and network adapters 116, e.g., network interfaces, that are connected to an interconnect 113. The interconnect 113 is illustrated as an abstraction that represents any one or more separate physical buses, point-to-point connections, or both connected by appropriate bridges, adapters, or controllers. The interconnect 113, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called Firewire.

The memory 112 and storage devices 114 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer-readable media can include computer-readable storage media, e.g., non-transitory media, and computer-readable transmission media.

The instructions stored in memory 112 can be implemented as software and/or firmware to program the processor 111 to carry out the actions described above. In some embodiments, such software or firmware may be initially provided to the processing system 110 by downloading it from a remote system through the computing system 110, e.g., via network adapter 116.

The various embodiments introduced herein can be implemented by, for example, programmable circuitry, e.g., one or more microprocessors, programmed with software and/or firmware, or entirely in special-purpose hardwired (non-programmable) circuitry, or in a combination of such forms. Special-purpose hardwired circuitry may be implemented using, for example, one or more ASICs, PLDs, FPGAs, etc.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as outlined in the following claims.

From the foregoing, it will be appreciated that specific embodiments of the disclosed herein have been described for purposes of illustration, but that various modifications may be made without deviating from the scope. Accordingly, the disclosure is not limited except as by the appended claims.

I/We claim:

1. A smart image scaling apparatus, comprising:
an image modification app configured to:
receive an initial image;
select an object within the initial image;
make a copy of the object;
store information about the relative position of the object within the initial image;
remove the object from the initial image, thereby generating an object-free image;
identify the region within the object-free image corresponding to the removed object;
apply AI techniques to fill in the identified region, thereby producing a completed object-free image;
a smart scaling engine configured to:
receive an initial aspect ratio corresponding to the initial image and a final aspect ratio corresponding to a final image;
generate scaling parameters based on the initial and final aspect ratios;
define a first and a second axis for the object-free image;
split the object-free image along either the first or second axis into
a plurality of bands, using a first width determined by the scaling parameters;
expand the split image by inserting empty bands between the split bands, using a second width determined by the scaling parameters, thereby creating a scaled partial image;
the image modification app further configured to:
apply AI techniques to fill in the empty bands, thereby generating a scaled image; and
reposition the copied object within the scaled image based on the stored relative position data.

2. The smart image scaling apparatus of claim 1, further comprising:
the object modification app, further configured to:
select at least one additional object within the initial image;
make copies of the additional object(s);
store information about the relative position(s) of the object(s) within the initial image;
remove the additional object(s) from the initial image, thereby generating an object-free image; and
reposition the additional object(s) within the scaled image based on the stored relative position data.

3. The smart image scaling apparatus of claim 1, further comprising:
the smart scaling engine further configured to:
receive data representing the dimensions for the initial image and a larger final image; and
expand the initial image proportionally along both axes until a first dimension of the initial image matches the corresponding dimension of the final image, while a second dimension of the initial image remains less than the corresponding dimension of the final image.

4. The smart image scaling apparatus of claim 1, further comprising:
the smart scaling engine further configured to:
receive data representing the dimensions for the initial image and a smaller final image; and
contract the initial image proportionally along both axes until a first dimension of the initial image matches the corresponding dimension of the final image, while a second dimension of the initial image remains less than the corresponding dimension of the final image.

5. The smart image scaling apparatus of claim 1, further comprising:
the object modification app, further configured to apply AI techniques to determine the boundaries of the selected object.

6. A method for scaling an image, comprising:
with a processor:
receiving an initial image, an initial aspect ratio corresponding to the initial image, and a final aspect ratio;
generating scaling parameters based on the initial and final aspect ratios;
defining a first and a second axis for the initial image;
splitting the initial image along either the first or the second axis into a plurality of bands, using a first width determined by the scaling parameters;
expanding the split image by inserting empty bands between the split bands, using a second width determined by the scaling parameters, thereby creating a scaled partial image;
applying AI techniques to fill in the empty bands, thereby generating a complete scaled image.

7. The method of claim 6, further comprising:
with a processor:
selecting an object within the initial image;
making a copy of the object;
storing information about the relative position of the object within the initial image; and
removing the object from the initial image.

8. The method of claim 7, further comprising:
with a processor:
identifying the region within the initial image corresponding to the removed object; and
applying AI techniques to fill in the identified region.

9. The method of claim 8, further comprises using a processor to reposition the copied object within the scaled image based on the stored relative position data.

10. The method of claim 9, further comprising:
with a processor:
selecting at least one additional object within the initial image;
making copies of the additional object(s);
storing information about the relative position(s) of the object(s) within the initial image;
remove the additional object(s) from the initial image; and
repositioning the additional object(s) within the scaled image based on the stored relative position data.

11. The method of claim 6, further comprising:
with a processor:
receiving data representing the dimensions for the initial image and a larger final image; and
expanding the initial image proportionally along both axes until a first dimension of the initial image matches the corresponding dimension of the final image, while a second dimension of the initial image remains less than the corresponding dimension of the final image.

12. The method of claim 6, further comprising:
with a processor:
receiving data representing the dimensions for the initial image and a smaller final image; and
contracting the initial image proportionally along both axes until a first dimension of the initial image matches the corresponding dimension of the final image, while a second dimension of the initial image remains less than the corresponding dimension of the final image.

13. The method of claim 6, further comprises using a process to apply AI techniques to determine the boundaries of the selected object.

14. A system for smart image scaling, the system comprising:
at least one processor:
at least one non-transitory memory, coupled to the at least one processor and
storing instructions, which when executed by the at least one processor, perform a process, the process comprising:
receiving an initial image, an initial aspect ratio corresponding to the initial image, and a final aspect ratio;
generating scaling parameters based on the initial and final aspect ratios;
defining a first and a second axis for the initial image;
splitting the initial image along either the first or the second axis into a plurality of bands, using a first width determined by the scaling parameters;
expanding the split image by inserting empty bands between the split bands, using a second width determined by the scaling parameters, thereby creating a scaled partial image;
applying AI techniques to fill in the empty bands, thereby generating a complete scaled image; and
inserting an object into the scaled image.

15. The system of claim 14, wherein the process further comprises:
selecting an object within the initial image;
making a copy of the object;
storing information about the relative position of the object within the initial image; and
removing the object from the initial image.

16. The system of claim 15, wherein the process further comprises:
identifying the region within the initial image corresponding to the removed object; and
applying AI techniques to fill in the identified region.

17. The system of claim 16, wherein the process further comprises using the stored relative position data to insert the additional object into the scaled image at the same relative position it was removed from in the initial image.

18. The system of claim 17, wherein the process further comprises:
selecting at least one additional object within the initial image;
making copies of the additional object(s);
storing information about the relative position(s) of the object(s) within the initial image;
removing the additional object(s) from the initial image, thereby generating an object-free image; and
using the stored relative position data to insert the additional object(s) into the scaled image at the same relative position they were removed from in the initial image.

19. The system of claim 14, wherein the process further comprises:
receiving data representing the dimensions for the initial image and data representing the dimensions for a larger final image; and
expanding the initial image proportionally along both axes until a first dimension of the initial image matches the corresponding dimension of the final image, while a second dimension of the initial image remains less than the corresponding dimension of the final image.

20. The system of claim 14, wherein the process further comprises:
receiving data representing the dimensions for the initial image and a smaller final image; and
contracting the initial image proportionally along both axes until a first dimension of the initial image matches the corresponding dimension of the final image, while a second dimension of the initial image remains less than the corresponding dimension of the final image.
